(19) United States
(12) Patent Application Publication
(10) Pub. No.: US 2005/0120609 A1
(43) Pub. Date: Jun. 9, 2005

(54) Shark deterrent device

(76) Inventor: Jacques Chauvet, New York, NY (US)

Correspondence Address: COLLIER SHANNON SCOTT, PLLC, 3050 K STREET, NW, SUITE 400, WASHINGTON, DC, 20007, US

(21) Appl. No.: 10/959,120

(22) Filed: Oct. 7, 2004

Related U.S. Application Data
(60) Provisional application No. 60/508,873, filed on Oct. 7, 2003.

(51) Int. Cl. A01K 81/00; A01K 81/04

(52) U.S. Cl. 43/6

(57) ABSTRACT

A shark deterrent device is disclosed. The device comprises at least two hollow cylindrical shafts, a tip, a twist-release mechanism, and at least one self-lock mechanism. The tip may be replaceable. The shark deterrent device is a retractable unit that is easy for a diver to carry and stow, and yet can be extended in order to deter a shark. The device is unlocked from its retracted position by twisting a collar, thereby unlocking the concentric shafts and allowing the unit to be fully extendable by hand. Once the unit is fully extended, a self-lock mechanism lock the unit to prevent it from retracting during use. The unit has a handle formed at one end of the outermost cylindrical shaft and a tip at the opposing end of the innermost cylindrical shaft. The tip may be replaceable and removed, and other useful tips may be attached.

### CROSS-REFERENCE TO RELATED APPLICATIONS

The present invention relates to, and is entitled to the benefit of the earlier filing date and priority of, Application No. 60/508,873, filed on Oct. 7, 2003, which is herein incorporated by reference as if fully set forth.

### FIELD OF THE INVENTION

The present invention relates to a device for deterring shark attacks. In particular, the device provides the user with a telescopic blunt object with which to prevent a shark from coming too close, while reducing the potential for injury to the shark.

### BACKGROUND OF THE INVENTION

Shark attacks are a common fear of scuba divers. In order to prevent these attacks, divers often carry with them various shark deterrents, such as chemical repellents or spear guns. Chemical repellents are often not allowed in ecological fragile areas, and are often of only limited effectiveness.

Spear guns are quite large to carry and are often not allowed in certain dive areas. It is typically only necessary to ward off the shark rather than injure it with a device such as a spear gun. An injury resulting in a loss of blood from the shark will likely attract other sharks and would pose an additional threat to the diver. It may be sufficient to prod, bump, or strike the shark when it advances with a device according to an embodiment of the present invention.

Sharks rarely attack in a straight forward manner. The most common method of shark attack is known as a “circling attack.” A circling attack is when a shark starts to circle its prey widely, and gradually reduces the diameter of the circle until the shark is close enough to “bump” its snout into the prey. This “bump” allows the shark to use its electroreceptors to identify its prey before the “test bite.” Since sharks are known to be scavengers they often are attracted to an easy prey. When sharks encounter prey that fights back, they have been known to retreat.

Thus, there is a need in the industry for a non-chemical, non-wounding device that will deter sharks and yet is easy for a diver to carry. This device may be used when a shark attempts to approach or “bump” a diver, acting as a deterrent and causing the shark to retreat and leave the diver in search of easier prey.

### SUMMARY OF THE INVENTION

Responsive to the foregoing challenges, Applicant has developed an innovative device for deterring sharks. The device is comprised of at least two, and in one embodiment three hollow cylindrical shafts, a replaceable and/or interchangeable tip, a twist-release, or similar release, mechanism, and at least one, and in one embodiment, two self-lock mechanisms. The shark deterrent is a retractable unit that is easy for a diver to carry and stow, and yet can be easily extended in order to deter a shark. The device is unlocked from its retracted position by twisting a collar or using a similar release mechanism, thereby unlocking the concentric shafts and allowing the unit to be fully extended. Once the unit is fully extended, self-lock mechanisms lock the unit to prevent it from retracting during use. The unit has a handle formed at one end of the outermost cylindrical shaft and a replaceable and/or interchangeable tip at the opposing end of the innermost cylindrical shaft. The replaceable tip may be removed, and other useful tips may be attached. In various embodiments, the interchangeable tips may include, but are not limited to, a hook, a spear, a net, a flashlight, or a shovel.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

In order to assist in the understanding of this invention, reference will now be made to the appended drawings, in which like reference characters refer to like elements.

FIG. 1 is a cross-section of an embodiment of the present invention in an extended position.

FIG. 2 is a cross-section of an embodiment of the present invention in a retracted position.

FIG. 3 is a cross-section detail view of an embodiment of the handle end of the present invention, when the embodiment is in a retracted position.

FIG. 4 is a cross-section detail view of the self-lock mechanism according to an embodiment of the present invention.

FIG. 5 is a cross-section detail view of the connection of the telescopic cylindrical shafts of an embodiment of the present invention.

FIG. 6 is a cross-section of one embodiment of a replaceable tip for an embodiment of the present invention.

FIG. 7 is a cross-section of an embodiment of the present invention in its extended position.

FIG. 8 is a plane view of an embodiment of the present invention in its extended position.

FIG. 9 is a cross-section detail view of an embodiment of the handle end of the present invention when the present invention is in a retracted position.

### DETAILED DESCRIPTION OF THE EMBODIMENTS OF THE INVENTION

Reference will now be made in detail to embodiments of the present invention, examples of which are illustrated in the accompanying drawings. As embodied herein, the present invention is a diver's utility tool, one embodiment of which is a shark deterrent device.

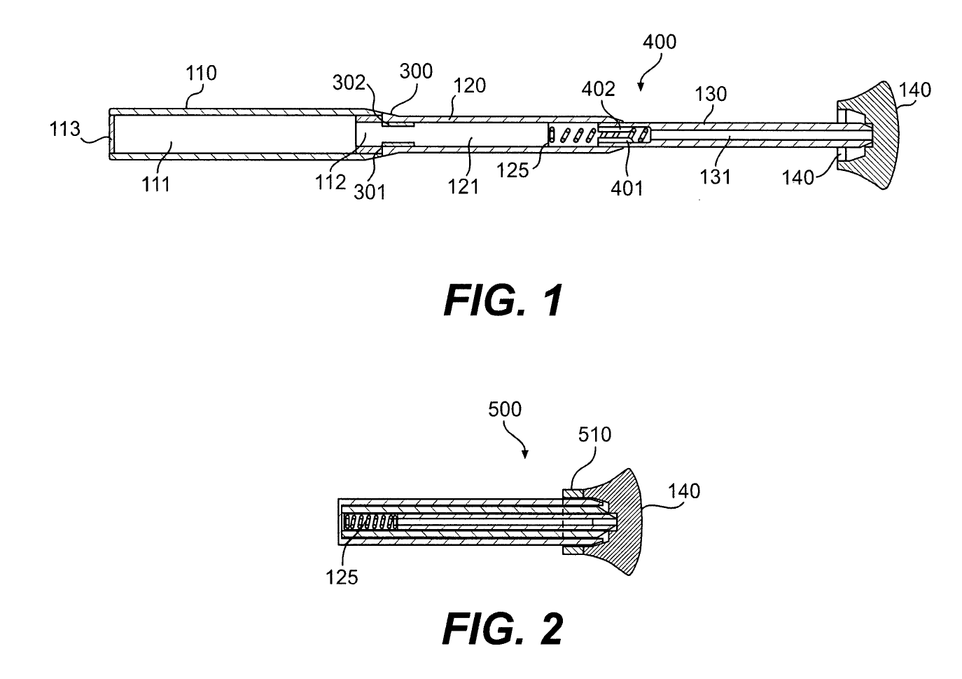

An embodiment of the present invention is shown in FIG. 1 as a shark deterrent device. The shark deterrent device comprises at least one cylindrical shaft. As shown in FIG. 1, the shark deterrent device comprises three cylindrical shafts, first hollow cylindrical shaft 110, second hollow cylindrical shaft 120, third hollow cylindrical shaft 130, and tip 140. Embodiments of the present invention may include, but are not limited to, one, two, or three or more cylindrical shafts.

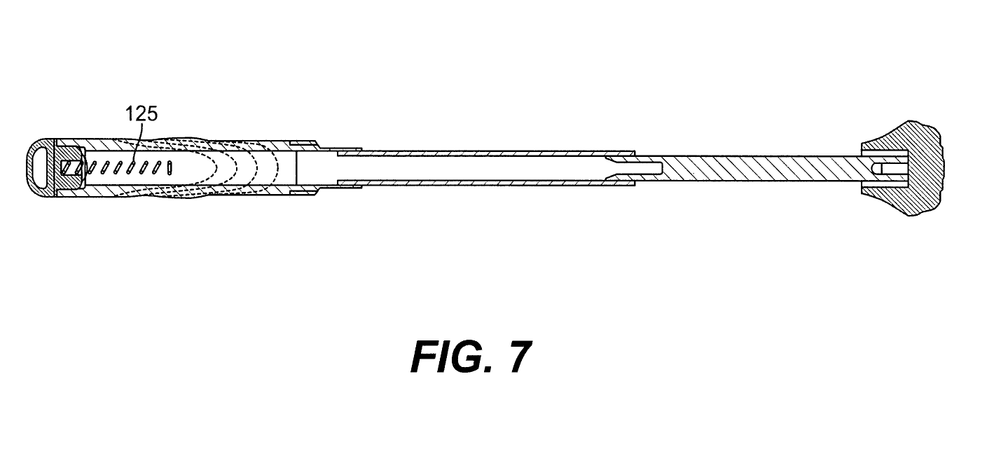

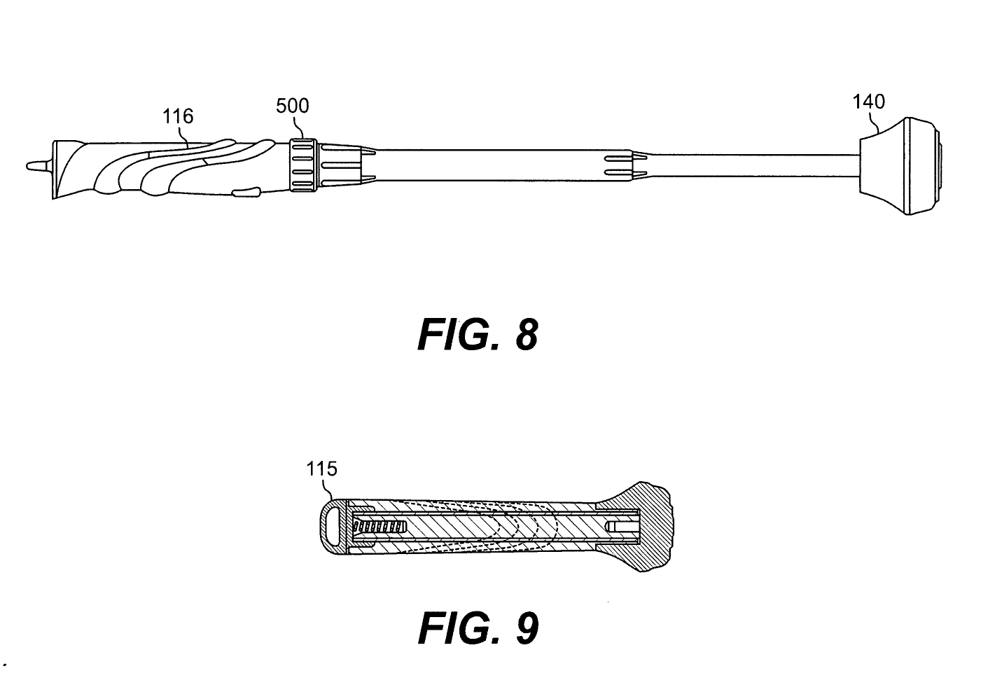

With reference to FIGS. 1-9, in one embodiment a first hollow cylindrical shaft 110 comprises closed end 113, open end 112, and first internal cavity 111. First hollow cylindrical shaft 110 has second hollow cylindrical shaft 120 slideably disposed within first internal cavity 111. Second hollow cylindrical shaft 120 likewise has third hollow cylindrical shaft 130 slideably disposed within second internal cavity 121. This arrangement allows a telescopic action of the device, thereby enabling it to retract and extend. FIG. 1 shows the device in a fully extended position while FIG. 2 shows the device in a fully retracted position. Replaceable tip 140 is attached to an end of third hollow cylindrical shaft 130. Shoulder 114 does not extend the entire circumference of first hollow cylindrical shaft 130. Instead, shoulder 114 may provide a plurality of shoulders that twist-release mechanism 145 engages.

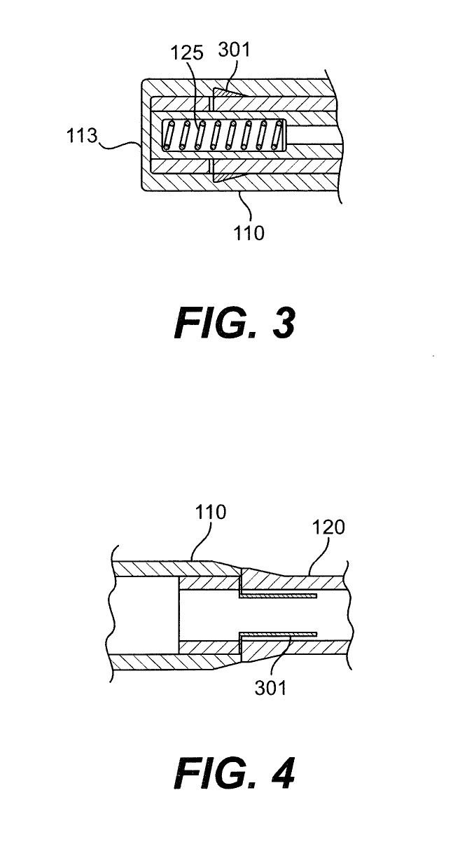

FIG. 3 is a detail view of the device in a fully retracted position.

FIG. 4 is a detail view of a self-lock feature 300. To prevent the device from retracting during use, self-lock feature 300 is used. Self-lock feature 300 may include a shoulder 301 on second hollow cylindrical shaft 120, and a fastening device 302 positioned within second hollow cylindrical shaft 120. When second hollow cylindrical shaft 120 is extended its full amount from the first internal cavity 111 of first hollow cylindrical shaft 110, shoulder 301 will slide out of first internal cavity 111 and butt against open end 112 of first hollow cylindrical shaft 110. Fastening device 302 is biased radially outward from second internal cavity 121 such that when shoulder 301 butts open end 112 it moves radially outward preventing shoulder 301 from being able to retract into first internal cavity 111.

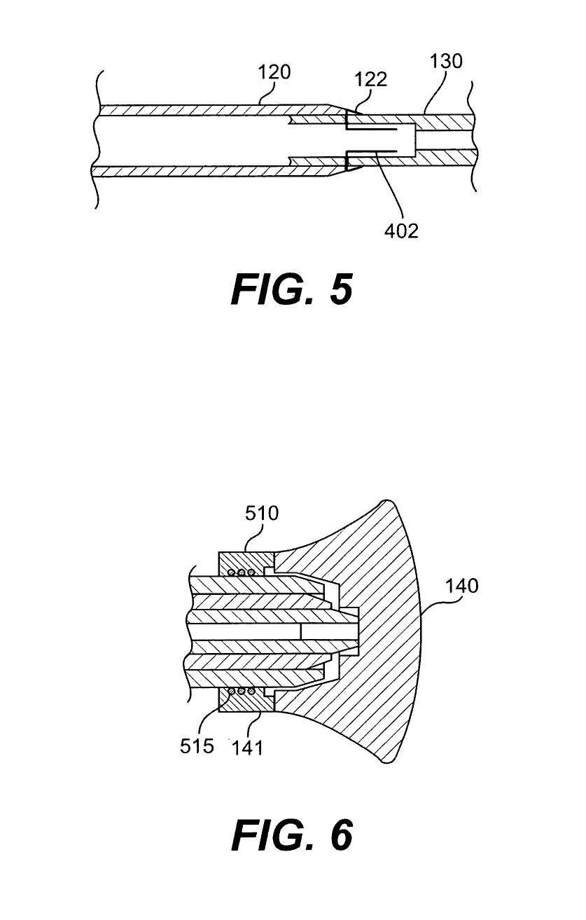

FIG. 5 shows a detail of the connection between second hollow cylindrical shaft 120 and third hollow cylindrical shaft 130. Third hollow cylindrical shaft 130 is prevented from retracting fully into second hollow cylindrical shaft 120 by self-lock 400. Self-lock 400 may include a shoulder 401 on third hollow cylindrical shaft 130, and fastening device 402 positioned within third hollow cylindrical shaft 130. When third hollow cylindrical shaft 130 is extended its full amount from second internal cavity 121 of second hollow cylindrical shaft 120, shoulder 401 will slide out of second internal cavity 121 and butt against end 122 of second hollow cylindrical shaft 120. Fastening device 402 is biased radially outward from third internal cavity 131 such that when shoulder 401 butts end 122 it moves radially outward preventing shoulder 401 from being able to retract into second internal cavity 121.

FIG. 6 shows replaceable tip 140 in relation to first, second, and third hollow cylindrical shafts 110, 120, and 130, respectively. Replaceable tip 140 is attached to one end of third hollow cylindrical shaft 130 in such a manner as to allow it to be easily removed and replaced with a second tip by an operator. Replaceable tip 140 has cavity 141 which allows replaceable tip 140 to collapse over first hollow cylindrical shaft 110, second hollow cylindrical shaft 120, and third hollow cylindrical shaft 130 when the device is in its retracted state. Replaceable tip 140 may also include shoulders 142, which may be engaged by twist-release mechanism 500 to prevent the device from extending until so desired.

Twist-release mechanism 500 is positioned on the outside surface of first hollow cylindrical shaft 110. Twist-release mechanism 500 may include collar 510 that locks onto shoulders 141 on first hollow cylindrical shaft 110, thereby preventing the device from extending. When twist-release mechanism 500 is not released, spring 125 is prevented from extending third hollow cylindrical shaft 130 out of first hollow cylindrical shaft 110 and second hollow cylindrical shaft 120. When collar 510 is rotated to an unlock position, the bias of spring 125 pushes third hollow cylindrical shaft 130 partially out of first hollow cylindrical shaft 110 and second hollow cylindrical shaft 120. The device is then unlocked, and a user can fully extend the device by hand. Collar 510 is biased by a torsion spring 515 such that when an operator releases collar 510, it returns to its original position, thereby re-engaging shoulders 141 when the device is retracted and re-locking the device in a closed position.

With reference to FIGS. 1-9, the operation of the device will now be explained. To extend the device, the operator twists collar 510 against the bias of torsion spring 515, thereby unlocking the device. Third hollow cylindrical shaft 130 is then forced out of first hollow cylindrical shaft 110 and second hollow cylindrical shaft 120 by the bias of spring 125. The operator then can grasp the device and extend it to its full length. Upon reaching its full length, self-locks 300 and 400 lock the device in its extended position. To close the device the operator first pushes in on fastening devices 301 and 401, and slides third hollow cylindrical shaft 130 into second hollow cylindrical shaft 120, and second hollow cylindrical shaft 120 into first hollow cylindrical shaft 110. When first, second, and third hollow cylindrical shafts 110, 120, and 130, respectively, are in the fully retracted position, collar 510 under the bias of torsion spring 515, automatically locks again over shoulders 141.

It will be apparent to those skilled in the art that variations and modifications of the present invention can be made without departing from the scope or spirit of the invention. Thus, it is intended that the present invention cover all such modifications and variations of the invention, provided they come within the scope of the appended claims and their equivalents.

1. A shark deterrent device comprising:
at least two concentric hollow cylindrical shafts, each with an open end and a closed end, slidably disposed within each other and adapted for telescopic extension; and
a tip, attached to the closed end of one of the hollow cylindrical shafts.

2. The shark deterrent device of claim 1, wherein the tip is blunt.

3. The shark deterrent device of claim 1, wherein the tip incorporates a flashlight.

4. The shark deterrent device of claim 1, wherein the tip is a hook.

5. The shark deterrent device of claim 1, wherein the tip is removable.

6. The shark deterrent device of claim 1, wherein the device is adapted to be neutrally buoyant.

7. The shark deterrent device of claim 1, further comprising:
a twist-release mechanism, adapted to unlock the at least two concentric hollow cylindrical concentric shafts from a retracted position; and
a self-lock, adapted to lock the at least two concentric hollow cylindrical concentric shafts in an extended position.

8. A shark deterrent device comprising:
a first hollow cylindrical shaft;
a second hollow cylindrical shaft, slidably disposed within the first hollow cylindrical shaft;
a twist-release mechanism, adapted to release the concentric shafts and enable the shafts to slide;
a first self-lock, adapted to lock the second hollow cylindrical shaft and the first hollow cylindrical shaft in an extended position preventing the second hollow cylindrical shaft from retracting into the first hollow cylindrical shaft; and
a tip attached to one of the hollow cylindrical shafts.

9. The shark deterrent device of claim 8, further comprising a third hollow cylindrical shaft, slidably disposed within the second hollow cylindrical shaft.

10. The shark deterrent device of claim 9, further comprising a second self-lock, adapted to lock the third hollow cylindrical shaft and the second hollow cylindrical shaft in an extended position preventing the third hollow cylindrical shaft from retracting into the second hollow cylindrical shaft.

11. The shark deterrent device of claim 8, wherein the tip is replaceable.

12. The shark deterrent device of claim 8, wherein the device is adapted to be neutrally buoyant.

13. A neutrally buoyant shark deterrent device comprising:
a first hollow cylindrical shaft;
a second hollow cylindrical shaft, slidably disposed within the first hollow cylindrical shaft;
a twist-release mechanism, adapted to release the concentric shafts and enable the shafts to slide;
a first self-lock, adapted to lock the second hollow cylindrical shaft and the first hollow cylindrical shaft in an extended position preventing the second hollow cylindrical shaft from retracting into the first hollow cylindrical shaft; and
a tip.

14. A neutrally buoyant shark deterrent device comprising:
a first hollow cylindrical shaft;
a second hollow cylindrical shaft, slidably disposed within the first hollow cylindrical shaft;
a third hollow cylindrical shaft, slidably disposed within the second hollow cylindrical shaft;
a twist-release mechanism, adapted to release the concentric shafts and enable the shafts to slide;
a first self-lock, adapted to lock the second hollow cylindrical shaft and the first hollow cylindrical shaft in an extended position preventing the second hollow cylindrical shaft from retracting into the first hollow cylindrical shaft;
a second self-lock, adapted to lock the third hollow cylindrical shaft and the second hollow cylindrical shaft in an extended position preventing the third hollow cylindrical shaft from retracting into the second hollow cylindrical shaft; and
a replaceable tip.
